(19) United States
(12) Patent Application Publication
(10) Pub. No.: US 2002/0189351 A1
(43) Pub. Date: Dec. 19, 2002

(54) ANGULAR RATE SENSOR HAVING A SENSE ELEMENT CONSTRAINED TO MOTION ABOUT A SINGLE AXIS AND FLEXIBLY ATTACHED TO A ROTARY DRIVE MASS

(76) Inventors: John W. Reeds, San Juan Capistrano, CA (US); Ying W. Hsu, Huntington Beach, CA (US)

Correspondence Address: Joseph C. Andras, MYERS DAWES & ANDRAS LLP, Suite 1150, 19900 MacArthur Boulevard, Irvine, CA, 92612, US

(21) Appl. No.: 09/882,807

(22) Filed: Jun. 14, 2001

(51) Int. Cl. G01P 15/08

(52) U.S. Cl. 73/504.04

(57) ABSTRACT

Disclosed is a micro-gyro and method of driving a micro-gyro. The method and structure are embodied in a micro-gyro of the type where first flexures extend from an anchor connect to a sense plate, where second flexures extend from the sense plate connect to a drive ring, where the drive ring is driven to oscillate about a drive axis, and where the first flexures constrain the sense plate from moving about the drive axis but permit the sense plate and the attached drive ring to rock about a sense axis. The sense plate, drive ring and flexures form a plate-ring-flexure system that is tuned such that the system rocks about the sense axis in a first or fundamental mode where the plate and ring move substantially in phase at the lowest resonant frequency.

### FIELD OF THE INVENTION

The present invention relates generally to sensors and, more particularly, to a method of driving and structure for an angular rate sensor having a sense element that is substantially restricted to motion about a single axis.

### BACKGROUND OF THE RELATED ART

This invention involves a class of sensors that use a vibratory element for measuring angular velocity. These sensors (including others of different construction) are commonly referred to as gyros (for gyroscopes), or in the case or very small gyros, micro-gyros. In micro-gyros, the elements are small, typically around 1 square millimeter.

Micro-gyros are generally produced from silicon wafers, using photolithographic techniques, in accordance with the principles of Micro-Electro-Mechanical Systems (MEMS). The small size of these elements enables large numbers of micro-gyros to be formed from a single silicon wafer using micro-fabrication techniques.

A micro-gyro measures the angular rate of rotation about an input axis or so-called “rate axis”. Micro-gyros may generally be classified as linear or as rotary. In either case, a mass is driven into vibration relative to a “drive axis” that is orthogonal to the rate axis. An electrostatic comb-drive structure is commonly used to oscillate the mass. If the mass is subject to rotation about the sensor's rate axis at some angular rate of rotation, then oscillatory coriolis forces acting on the vibrating mass will naturally cause it to also vibrate relative to a “sense axis” that is orthogonal to the rate and drive axes. The coriolis force generated is proportional to the rate of rotation of the sensor about the rate axis and the amplitude of oscillation (at the applied drive frequency) of the inertial mass about the drive axis.

Some micro-gyro embodiments have only a single “proof mass” that is both driven and sensed. U.S. Pat. No. 5,992,233 entitled “MICROMACHINED Z-AXIS VIBRATORY RATE GYROSCOPE” is representative of a linear micro-gyro wherein a single “proof mass” is driven into vibration along a drive axis and wherein coriolis-induced motions of that same proof mass are detected along a sense axis that is orthogonal to the drive axis. The proof mass, in other words, is both the drive mass and the sense mass.

Other micro-gyros provide a drive mass that quite literally carries a sense mass. The sense mass is coupled to and moves with the drive mass as both vibrate relative to the drive axis, but the sense mass is free to move relative to the sense axis under the presence of coriolis forces.

U.S. Pat. No's 5,377,544; 5,450,751; 5,226,321; 5,349,855; 6,067,858; and 5,349,855 are exemplary of gyros where the rate sensing element is a part of the driven structure, and is therefore in motion even in the absence of any rate input. This continuous motion of the sense element relative to the drive axis can produce a sense output due to changes in the fringing effects of sense capacitors, manufacturing tolerances in surface contours or planarity, and other influences. These effects can be very significant, because the amplitude of the desired sense motion may be an order of magnitude or more below that of the drive motion, so any secondary influences caused by the drive motion may create an excessively large noise in the sense signal. A design in which the inertial mass may be driven about the drive axis without inducing a motion in the sense element in the absence of a rate input would therefore be highly preferable.

In U.S. Pat. No. 5,408,877 and 5,515,724 a gyro is introduced wherein the inertial mass may be driven independent of the sense element. A similar concept was presented earlier in U.S. Pat. No. 5,488,862. These design concepts, however, are specifically limited to a gimballed drive sensing a rate input about an axis perpendicular to the plane of the substrate, typically referred to as the z-axis. A device sensitive to rotational rate about one of two axes in the plane of the substrate, typically referred to as the x-axis and the y-axis, is generally preferred; as it permits two gyro axes to be established in a single substrate plane. This also allows the possibility of producing a 2-axis gyro on a single chip, with essentially perfect orthogonality. The '877/'724 and '862 designs are also poorly adapted for many basic micromachining processes, because in order to achieve a substantial motion of the inertial mass about the in-plane drive axis, a deep pit must be formed under the inertial mass. This would require an additional and relatively expensive process step.

A unique micro-gyro developed by the assignee of this invention is disclosed in U.S. Pat. No. 5,955,668. The '668 patent is commonly owned by the assignee of this invention and hereby incorporated by reference in its entirety.

The gyro design in the '668 patent may be regarded as an x-axis or y-axis gyro because it is sensitive to a rotation about an axis in the plane of the substrate. In the preferred embodiment, the '668 patent discloses a sense mass provided as a disk-shaped sense plate and a drive mass provided as a ring. The sense plate is supported from two anchors extending above the substrate. The ring, in turn, is supported by flexures extending from the sense plate and it surrounds the sense plate. The drive ring and sense plate are statically decoupled in that the drive ring can move independently about the drive axis. In the absence of a rotational rate input, and under ideal conditions, the driven mass is vibrated but the sense element remains still. In the presence of rotational rate, however, coriolis-induced energy is dynamically transferred from the drive mass (vibratory element) to the sense element through the flexures. In addition to being statically decoupled about the drive axis, the drive and sense masses are dynamically decoupled in that the natural resonant frequencies of the design are tuned such that when the sense element responds to a coriolis force in the presence of a rate input, the sense mass moves about the sense axis but the drive mass does not substantially move about the sense axis.

The '668 patent discloses that the rocking motion of the disk about the sense axis does not move the ring, and that any energy tending to create such motion “is absorbed in the structure with substantially no effect.” (see e.g. Col. 7, lines 22-32). In order to achieve the dynamic decoupling mentioned above, therefore, the plate-ring-flexure system in the '668 patent was specifically designed to operate in a second mode where the plate and ring elements oscillate about the sense axis in substantial opposition to one another. The sense plate was dynamically decoupled from the ring by tuning the system to make the plate's amplitude of motion about the sense axis substantially greater than the ring's amplitude of motion about that same axis.

The '668 design was an improvement to the existing art, but other decoupled designs are possible. In particular, it could be advantageous for a micro-gyro to have an operational mode that is at or near the lowest natural resonant frequency of the device, while inhibiting the motion of the sense element with respect to the drive axis.

### SUMMARY OF THE INVENTION

The present innovation differs from the gyro disclosed in the '668 patent primarily in that although the sense element does not substantially move about the drive axis, the drive element does move about the sense axis with the sense element in the presence of an input rate. By designing the gyro such that both sense and drive elements move together in the sense mode, we beneficially allow it to operate at or near the lowest natural resonant frequency of the device while inhibiting the motion of the sense element with respect to the drive axis.

This design is also a considerable improvement over the '877/'724 and '862 designs, in that it is an x-axis or y-axis gyro. Because the z-axis is used as the drive axis, a relatively large displacement of the inertial mass is possible, limited primarily by the linear range of the rotation flexures. Also, it is possible to produce both x-axis and y-axis orientations on a single chip, ensuring orthogonality of the axes.

This design also resembles the '688 design and is distinct and superior to the '877/'724 design in that the drive mass is situated external to the centrally located sense mass. This allows the sense mass to be supported by a single centrally located anchor, minimizing any thermal stresses or warpage. This also provides a significant advantage in allowing the electrical connections to the drive electrodes to be routed without crossing under the sense element or any other part of the sensor structure.

The invention essentially isolates the inertia of the drive mass about the drive axis from directly influencing the sense element. The sense element is substantially restricted to a single-degree-of-freedom motion about the sense axis. In the preferred embodiment, the sense oscillation is a coupled mode in which the drive mass and the sense element move substantially in phase about the sense axis.

The preferred embodiment of the invention includes an outer ring-shaped drive mass which oscillates about a drive axis, and an inner plate which rocks in conjunction with the drive mass about an output axis in response to a coriolis force. The torque or resulting displacement about the output axis may be measured by any suitable means, such as capacitance, magnetic force, piezoelectric or piezoresistive effect, or optical signals.

The inner plate serves as a sensing element. In the preferred embodiment it is supported by a pair of hinges, flexures, or flexural arrangements essentially restricting the sensing plate to rocking about a single axis, known as the sense axis. The hinges are connected to one or more posts, also known as anchors, which serve to connect the device to the substrate. The outer drive mass is connected to the inner sense element by a plurality of hinges or flexural arrangements whose primary function is to permit rotation of the drive mass about the drive axis without causing the sense element to rotate about the drive axis. In the presence of a rate-induced coriolis force, these same flexural arrangements serve to couple the coriolis energy into the sense mass.

### BRIEF DESCRIPTION OF THE DRAWINGS

The just summarized invention can be best understood with reference to the following description taken in view of the drawings of which:

FIG. 1 is a simplified top plan view of a preferred embodiment of a micro-gyro 10 designed in accordance with this invention.

FIG. 2 is a further simplified and dimensionally exaggerated version of the micro-gyro of FIG. 1, the arrow showing the direction in which the ring 40 is driven to oscillate about a drive axis 21;

FIG. 3 is a sectional side view of the simplified micro-gyro 10 of FIG. 2, taken along the rate axis and section lines 3-3, showing the sense plate 20 and the drive ring 40 supported above the substrate by the anchor 25, the arrow generically showing that the ring-plate-flexure system 15 oscillates about the sense axis 23 in the presence of an oscillatory coriolis force;

FIG. 4 is a sectional side view that that shows a mode of oscillation that is consistent with the teachings of the '668 patent, where a substantially out of phase displacement of the sense plate 20 and the drive ring 40 is produced by coriolis force in the presence of a rotation about the rate axis; and

FIG. 5 is a sectional side view that shows a mode of oscillation that is representative of the preferred embodiment of this invention where a substantially in-phase displacement of the sense plate 20 and the drive ring 40 is produced by coriolis force in the presence of a rotation about the rate axis.

### DETAILED DESCRIPTION OF THE PREFERRED EMBODIMENTS

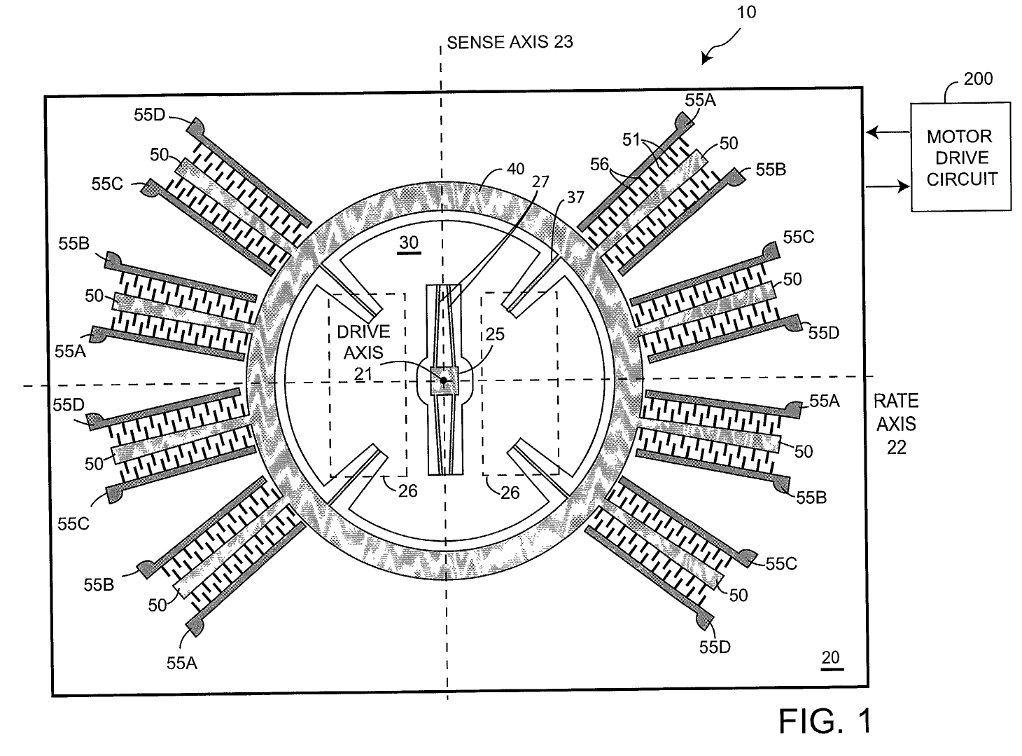

FIG. 1 is a simplified top plan view of a micro-gyro 10 that is designed and driven in accordance with this invention. It should be understood, however, that the inventive concepts of this invention may be adapted to a variety of micro-gyro configurations.

The main goal of the '668 patent was to provide a gyro that operated in a mode where the drive ring oscillated about the drive axis but the sense plate did not and where the sense plate rocked about the sense axis but the drive ring substantially did not. The '668 patent inherently relied on operating in the second mode where the sense plate and drive ring moved out of phase relative to one another about the sense axis.

The '668 patent represents a significant advancement, but it turns out that an operational mode not disclosed or suggested by the '668 patent has significant advantages of its own. In particular, these inventors have determined that for some applications there areadvantages to a micro-gyro system that operates in the first mode, where the sense plate and drive ring are moving together and where the drive ring's motion about the sense axis is therefore substantial. The resulting micro-gyro I can be even more resistant to excitation from environmental vibration.

Micro-Gyro Structure

FIG. 1 discloses a micro-gyro 10 that may be constructed and driven in accordance with the present invention. As shown, the micro-gyro 10 is of substantially planar construction, and it senses rotational rate about a rate axis 22 that is substantially parallel to the plane of the micro-gyro 10. The micro-gyro 10 shown, therefore, may be regarded as an x-axis or y-axis gyro.

In more detail, the micro-gyro 10 comprises a substrate 20, an anchor 25 extending upward from the substrate 20, and first inner flexures 27 that are connected to the anchor 25 and extending from the anchor 25 above and substantially parallel to the plane of the micro-gyro 10.

A sense plate 30 is flexibly connected to the anchor 25 via the first flexures 27. The sense plate 30 is constrained to a single-degree-of-freedom rocking motion about a sense axis 23 that is substantially parallel to the plane of the micro-gyro 10 and substantially perpendicular to the rate axis 22 because the geometry of first inner flexures 27 substantially prohibits rotation about the drive axis 21 and about the rate axis 22 and substantially permits a rocking motion about the sense axis 23. The sense plate 30 interfaces with one or more sense electrodes 26 as is well known in the art.

Second outer flexures 37 are connected to the sense plate 30 and extend from the sense plate 30 substantially parallel to the plane of the micro-gyro 10.

A drive ring 40 is flexibly connected to the sense plate 30 via the second flexures 37. The drive ring 40 moves about a drive axis 21 that is perpendicular to the plane of the micro-gyro and to both the rate and sense axes 22, 23. Due to the geometry of the first and second flexures 27, 37, the drive ring 40 can move about the drive axis 21 while the sense plate 30 remains stationary.

Lastly, a drive means for oscillating the drive ring 40 about the drive axis 21 is provided. In the embodiment shown, the drive means comprises a plurality of driven arms 50 that extend radially outward from the drive ring 40 between a pair of drive electrodes 55, a plurality of partially overlapping comb-fingers 51, 56 that form an electrostatic comb-drive structure, and a motor drive circuit 200 that suitably applies voltages that vibrate the ring element 40 at a desired frequency. The exact structure of the drive means is not critical to the present invention and any suitable drive means may be used.

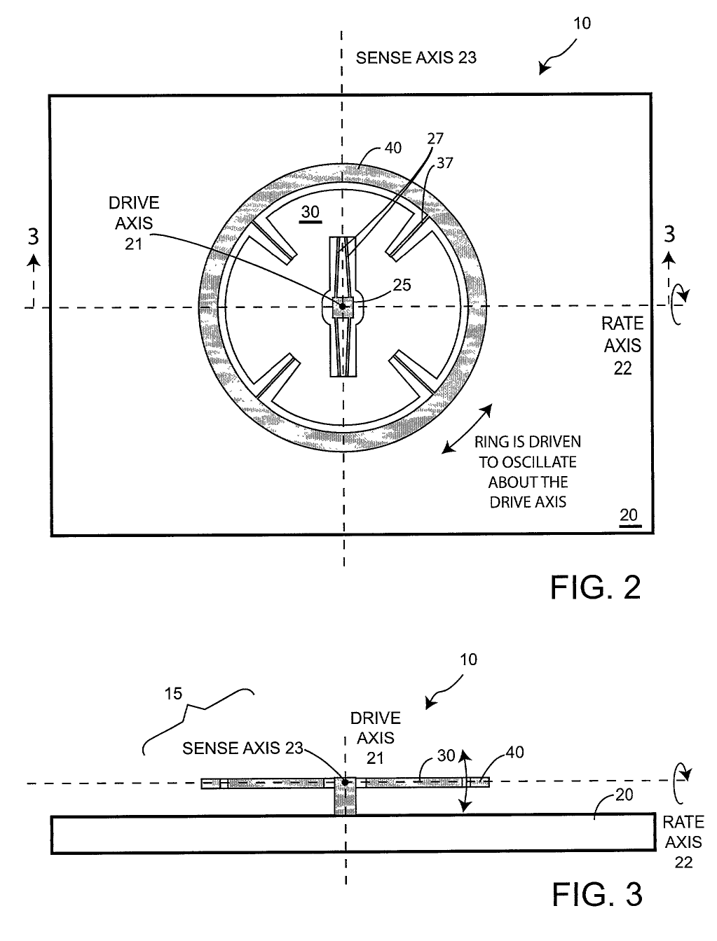

As more clearly shown in FIG. 2, the second flexures 37 and the drive ring 40 are suitably designed such that the drive ring 40 has a natural frequency f_{D}(natural) of oscilglation around the drive axis 21. The natural frequency f_{D}(natural) may be established using well-known methods of analysis that involve the variation of masses, geometries and stiffness. In the preferred embodiment, the actual drive frequency of the ring f_{D}(actual) is controlled to match the natural frequency f_{D}(natural), which is designed to be about 6,000 Hz.

Additionally, as best shown by viewing FIGS. 2 and 3 together, the first flexures 27, the sense plate 30, the second flexures 37 and the drive ring 40 form a plate-ring-flexure system 15, which has a natural sense frequency fs(natural) about the sense axis 23 that is close to the drive frequency f_{D}(actual). This allows for an efficient coupling of energy in the presence of coriolis forces. The natural sense frequency f_{S}(natural) is also established using well-known methods of analysis that involve the variation of masses, geometries and stiffness. In the preferred embodiment, f_{S}(natural) is designed to be about 5800 Hz.

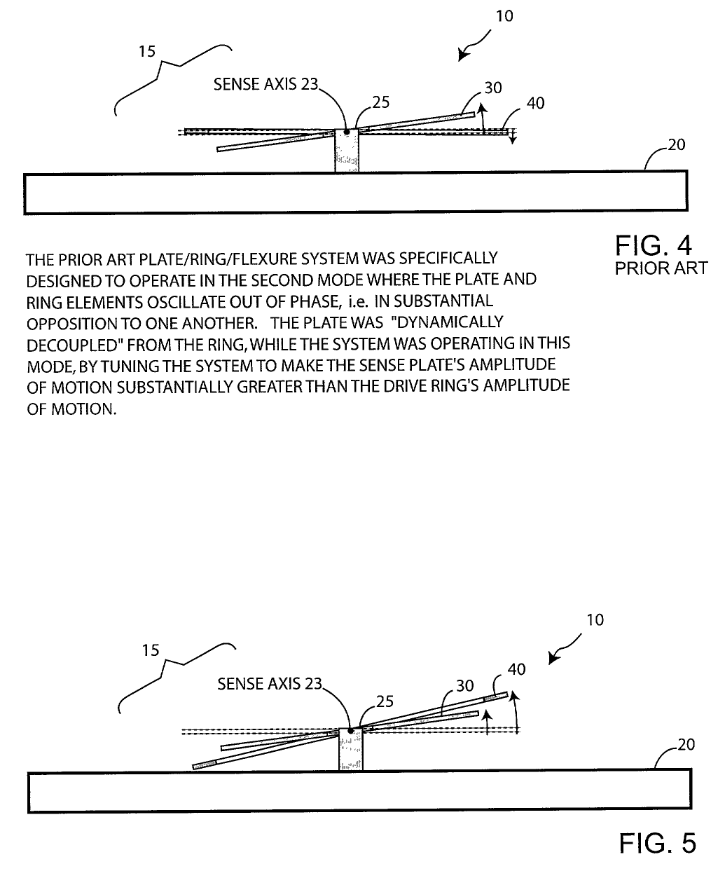

As shown in FIG. 4, the natural sense frequency f_{S}(natural) has previously been selected such that it corresponds to the natural frequency f_{S2}(natural) associated with a second mode of operation where the sense plate 30 and the drive ring 40 move substantially out of phase relative to one another.

As shown in FIG. 5, however, the plate-ring-system 15 in the preferred embodiment of this invention is uniquely designed to operate in a first mode where the plate 30 and ring 40 oscillate substantially in-phase due to coriolis acceleration in response to any rotation about the rate axis 22. This is accomplished by driving the ring at a drive frequency f_{D}(actual) that is close to a first fundamental mode frequency f_{S1}(natural) that constitutes a lowest natural resonant frequency of the plate-ring-flexure system 15 about the sense axis 23.

Method of Driving

Another embodiment of the invention is a method of driving a micro-gyro 10 that, with exemplary reference to FIG. 1, is comprised of a substrate 20, an anchor 25 extending upward from the substrate 20, a sense plate 30 supported from the anchor 25 by first flexures 27 that constrain its motion to a single-degree-of-freedom rocking motion about a sense axis 23; and a drive ring 40 supported from the sense plate 30 by second flexures 37 that permit the drive ring 40 to angularly oscillate about a drive axis 21 that is substantially perpendicular to the sense axis 23 and also permit the drive ring 40 to move in a rocking motion about the sense axis 23; the sense plate 30, the drive ring 40, and the first and second flexures 27 and 37 forming a plate-ring-flexure system 15 (see FIG. 2) that has a first resonant mode associated with a first natural frequency where the plate 30 and ring 40 rock substantially in phase about the sense axis 23 and a second resonant mode associated with a second natural frequency where the plate 30 and ring 40 rock substantially in opposite phase about the sense axis 23.

The method comprises the steps of (1) providing a drive means for angularly oscillating the drive ring 40 about the drive axis 23 such that a rotational rate of the micro-gyro 10 about a rate axis 22 that is substantially perpendicular to both the sense axis 23 and the drive axis 21 creates an oscillatory coriolis force that causes the plate-ring-flexure system 15 to angularly oscillate about the sense axis 23; and (2) oscillating the drive ring 40 about the drive axis 21 with the drive means at a drive frequency substantially matching the natural resonant frequency of the drive ring 40 about the drive axis 21, and close to the first natural frequency of the first resonant mode about the sense axis 23 of the plate-ring-flexure system 15 such that the plate 30 and ring 40 rock substantially in phase about the sense axis 23.

The preferred drive means for oscillating the drive ring 40 at the drive frequency comprises a plurality of driven arms 50 that extend radially outward from the drive ring 40 between a pair of drive electrodes 55, a plurality of partially overlapping comb-fingers 51, 56 that form an electrostatic comb-drive structure, and a motor drive circuit 200 that suitably applies voltages causing the ring element 40 to oscillate at the desired frequency. The exact structure of the drive means is not critical to the present invention and any suitable drive means may be used.

We claim:

1. A method of driving a micro-gyro comprised of a substrate, an anchor extending upward from the substrate, a sense plate supported from the anchor and above the substrate by first flexures that constrain its motion to a single-degree-of-freedom rocking motion about a sense axis, and a drive ring supported from the sense plate by second flexures that permit the drive ring to angularly oscillate about a drive axis that is substantially perpendicular to the sense axis and permits the drive ring to move in a rocking motion about the sense axis; the sense plate, the drive ring and the first and second flexures forming a plate-ring-flexure system that has a first resonant mode associated with a first natural frequency where the plate and ring rock substantially in phase about the sense axis and a higher resonant mode associated with a higher natural frequency where the plate and ring rock substantially in opposite phase about the sense axis, the method comprising the step of:
providing a drive means for angularly oscillating the drive ring about the drive axis such that a rotational rate of the micro-gyro about a rate axis that is substantially perpendicular to both the sense axis and the drive axis creates an oscillatory coriolis force that causes the plate-ring-flexure system to angularly oscillate about the sense axis; and
oscillating the drive ring with the drive means at a drive frequency that is near the first natural frequency of the first resonant mode of the plate-ring-flexure system such that the plate and ring rock substantially in phase about the sense axis.

2. A micro-gyro of substantially planar construction that senses rotational rate about a rate axis that is substantially parallel to a plane of the micro-gyro comprising:
a substrate;
an anchor extending upward from the substrate;
first inner flexures connected to the anchor and extending from the anchor above and substantially parallel to the plane of the micro-gyro;
a sense plate that is flexibly connected to the anchor via the first flexures and constrained to a single-degree-of-freedom rocking motion about a sense axis that is substantially parallel to the plane of the micro-gyro and substantially perpendicular to the rate axis;
second outer flexures connected to the sense plate and extending from the sense plate substantially parallel to the plane of the micro-gyro;
a drive ring that is flexibly connected to the sense plate via the second flexures, the second flexures and the drive ring designed to cause the drive ring alone to angularly oscillate at a natural frequency around the sense plate and about a drive axis that is substantially perpendicular to the plane of the micro-gyro and to the sense and rate axes, the drive ring driven about the drive axis at a drive frequency; and
the first flexures, the sense plate, the second flexures and the drive ring forming a plate-ring-flexure system wherein an angular motion of the system about the rate axis and the angular oscillation of the ring about the drive axis result in an angular response of the plate-ring-flexure system wherein the plate and ring oscillate substantially in-phase and substantially at the drive frequency, close to a first mode frequency that constitutes a lowest natural resonant frequency of the plate-ring-flexure system about the sense axis.

3. A micro-gyro of substantially planar construction that senses rotational rate about a rate axis that is substantially parallel to a plane of the micro-gyro comprising:
a sense plate that is connected to the substrate via first flexures that substantially constrain the sense plate to a rocking motion about a sense axis that is substantially parallel to the plane of the micro-gyro and substantially perpendicular to the rate axis;
a drive ring that is flexibly connected to the sense plate via second flexures that substantially permit the drive ring to oscillate about the drive axis at a drive frequency while the sense plate remains stationary about the drive axis,
the first flexures, the sense plate, the second flexures and the drive ring forming a plate-ring-flexure system wherein the plate and ring oscillate substantially in-phase at the drive frequency and close to a first mode frequency that constitutes a lowest natural resonant frequency of the plate-ring-flexure system about the sense axis.
